(19) United States
(12) Patent Application Publication
(10) Pub. No.: US 2009/0278528 A1
(43) Pub. Date: Nov. 12, 2009

(54) SENSOR FOR DETERMINING THE ELECTRICAL CONDUCTIVITY OF LIQUID MEDIA, AND METHOD FOR THE PRODUCTION THEREOF

(76) Inventors: Uwe Partsch, Dresden (DE); Holger Neubert, Dresden (DE)

Correspondence Address: GREENBLUM & BERNSTEIN, P.L.C., 1950 ROLAND CLARKE PLACE, RESTON, VA, 20191, US

(21) Appl. No.: 12/301,435

(22) PCT Filed: May 15, 2007
(86) PCT No.: PCT/EP07/54727

§ 371 Date: Mar. 25, 2009

(30) Foreign Application Priority Data
May 19, 2006 (DE) 102006025098.2

(51) Int. Cl. G01N 27/74

(52) U.S. Cl. 324/204; 29/602.1

(57) ABSTRACT

Sensor for determining the electrical conductivity of liquid media comprising a multilayer layered structure (1), with a carrier substrate with two wound (3b, 4b) magnetizable cores (3a, 4a) and a dielectric coating. The invention also comprises a method in which a greenbody for a magnetizable core with metallic windings is applied onto a dielectric ceramic base green film, and a second magnetizable core with metallic windings is applied and subsequently a coating is applied before or after the sintering. The invention further comprises a method in which magnetizable cores with metallic windings are applied onto a dielectric organic base plate or base film.

The invention relates to the fields of metrology and instrument manufacture and relates to a sensor for determining the electrical conductivity of liquid media, such as can be used, for example, in the chemical, food, beverage or pharmaceutical industries, as well as environmental technology and biotechnology for determining the concentration or the process control and a method for the production thereof.

Various methods utilizing different measuring principles are known for determining the electrical conductivity of liquid media.

With capacitive conductivity sensors a current is applied in the liquid with the aid of two electrodes coated with a dielectric, and the electrical conductivity of the liquid is determined from the voltage and the current at the electrodes (DE 40 22 563 A1).

An arrangement for the contactless measurement of the specific conductivity of aqueous solutions thereby comprises two coupled electrodes that apply an alternating current capacitively into a measuring cell (DE 195 37 059 A1). The coupled electrodes comprise a fired laminate of a foil of dielectric capacitor ceramic with a metalizing layer and a ceramic bearer, wherein through-hole platings are present to improve the mechanical stability of the coupled electrodes.

Furthermore, conductive conductivity sensors are known, which comprise a pair of electrodes, which applies an alternating current to a liquid. The voltage drop in the liquid is measured via a second pair of electrodes and the electrical conductivity of the liquid determined from current and voltage at the electrodes (U.S. Pat. No. 5,959,455 A; U.S. Pat. No. 6,414,493 B1).

The determination of the electrical conductivity by inductive measurement methods is likewise known. In principle, the sensors necessary for this purpose have at least two ring-core coils sealed against the liquid, wherein through the emitter coil the liquid is acted on with an alternating current, through which a current is applied into the liquid according to its electrical conductivity. A magnetic alternating field is generated by the emitter coil, which alternating field induces an electric voltage in the liquid. The ions present in the liquid render possible a current flow that increases with rising ion concentration. The current in the liquid generates a magnetic alternating field in the receiver coil. The induced current thereby forming in the receiver coil is measured and the electrical conductivity of the liquid determined therefrom.

The determined conductivity is a gauge for the ion concentration in the liquid.

A sensor operating inductively for measuring the electrical conductivity of a liquid medium is known for this purpose (DE 198 51 146 A1). The sensor comprises an excitation coil supplied with the input signal and a receiver coil coupled to the excitation coil via the liquid, which receiver coil supplies an output signal that is a gauge of the electrical conductivity of the liquid.

Furthermore, an inductive conductivity measuring cell is known with an emitter coil and a receiver coil and a short-circuit path with the medium to be measured, which medium penetrates the emitter coil and receiver coil (DE 41 16 468 C2).

A device is also known for measuring the conductivity of liquids with two annular cores of a magnetizable material, which are arranged coaxially to one another based on the axis (EP 0 470 367 B1). The cores have a winding that is respectively extended over only one narrow circumferential sector and the center tangent thereof, based on a section perpendicular to the axis, is arranged at right angles to one another. The measuring medium penetrating the ring core coils forms the jointly contacting and coupling electric conductor.

General studies on electric theory of the conductive and inductive sensors for determining the electrical conductivity are known according to D. Arnold and G. H. Meeten, J. Phys. E.: Schi. Instrum. 21 (1998) 448-453.

Likewise known are conductivity sensors, the concrete statistics and data of which are available from the technical information of various manufacturers (InduMax P CLS 50, InduMax H CLS 52, Endress+Hauser; InPro7250, Mettler Toledo).

According to the information thus known, in the use of the commercially available conductivity sensors with the measurement, however, the installation and the geometry of the sensor must also be taken into account. To this end a cell constant is given, which describes in full the geometry of the respective sensor. Likewise the installation factor must be taken into account, which, however, with greater wall spacing exerts less and less influence, which, however, also depends on the electrical conductivity of the tubes containing the liquid.

In order to not only empirically determine the respective influence conditions on the conductivity sensors, numerical models of inductive conductivity measurement systems are also known (M. Roos, et al., Fachtagung, Simulation mit der Finite-Element-Methode in Feinwerk-und Mikrotechnik, Mar. 12, 1996, Munich). The models contain critical geometric and electrical parameters for the characterization of the system behavior. With these parameters, optimization steps can be carried out to reduce power loss, to increase sensitivity and precision and to expand the measurement area.

The disadvantage with all of the known conductivity sensors is their relatively large construction volume with a limited sensitivity and a relatively complex production method due an assembly that must in part be manual.

The object of the invention is to disclose a sensor for determining the electrical conductivity of liquid media, which is available in any desired, much smaller dimensions and has at least the electrical properties of the sensors according to the prior art and a simpler and more cost-effective method for the production thereof.

The object is attained through the invention disclosed in the claims. Advantageous embodiments are the subject matter of the subordinate claims.

The sensor according to the invention for determining the electrical conductivity of liquid media comprises a multilayer layered structure, which comprises at least one carrier substrate, on which at least two magnetizable cores with metallic windings at least partially enclosing over the length of the cores are arranged, electrically conductive feed lines and drain lines to the windings of the at least two cores are available, and the multilayer layered structure is enclosed at least by a dielectric layer, wherein in order to exploit the inductive measuring principle, the arrangement of the sensor realizes an at least partial enclosure of the two wrapped and encased cores or core parts by the liquid at the same time.

Advantageously, the carrier substrate is an electrically nonconductive ceramic, an LTCC ceramic (Low Temperature Cofired Ceramic) or an Al₂O₃ ceramic.

The carrier substrate is also advantageously an organic material.

It is also advantageous if the organic material is phenolic resin+paper (FR1, FR2), epoxide resin+paper (FR3), epoxide resin+glass fiber cloth (FR4, FR5), polyimide and/or polyester.

Furthermore advantageously, the multilayered layers comprise a ceramic that sinters densely at temperatures up to a maximum of 900° C.

And it is also advantageous if the magnetizable cores comprise a soft magnetic material.

Likewise advantageously the magnetizable cores comprise a ferritic material, even more advantageously the ferritic material is used as a film or paste.

Furthermore advantageously, the magnetizable cores are used as preformed solid bodies.

It is furthermore advantageous if the windings are composed of Cu, Ag, Pd, Au, Al or combinations of these materials.

It is also advantageous if the magnetizable cores are arranged in an annular manner and/or one inside the other and/or one above the other and/or next to one another.

It is likewise advantageous if the magnetizable cores are surrounded by windings to 5 to 100%.

It is also advantageous if the magnetizable cores are surrounded by windings respectively up to a maximum of 50% and the windings are arranged opposite one another.

It is also advantageous if the entire multilayer layered structure has a height/thickness of 0.5 to 5 mm.

And it is also advantageous if the dielectric layer comprises a plastic or a glass.

It is furthermore advantageous if the signal transmission is realized via electric lines or by radio.

And it is likewise advantageous if further sensors are arranged on layers inside the multilayer layered structure, even more advantageously temperature sensors and/or pH sensors are arranged inside the ceramic multilayer layered structure.

It is likewise advantageous if several magnetizable pairs of cores with windings are present on a carrier substrate, wherein to exploit the inductive measuring principle the liquid surrounds at least in part all of the wound and encased cores or core parts simultaneously here too.

In the method according to the invention for producing a sensor for determining the electrical conductivity of liquid media, at least one greenbody for a magnetizable core of a ferritic ceramic material is applied onto a dielectric ceramic base green film, which greenbody is wrapped by a metallic wire, wherein to realize the inductive measuring principle at least one second magnetizable core with windings of a metallic wire is applied to the same or to a different dielectric ceramic film, and the windings have been plated-through by the ceramic film/films, subsequently the metallic windings are bonded with an electrically conductive compound and subsequently the sintering of the ceramic multilayer layered structure is carried out, wherein a dielectric encasing of the entire multilayer layered structure is applied before or after the sintering.

Advantageously, dielectric ceramic green films with a thickness of 50 to 250 μm are used.

Likewise advantageously, the sintering of the multilayer layered structure is carried out at temperatures of no more than 900° C.

It is also advantageous if an encasement of plastic or glass is applied at temperatures of no more than 900° C.

With the method according to the invention for producing a sensor for determining the electrical conductivity of liquid media, at least one magnetizable core is placed on an organic base film or base plate and covered with at least one further layer of organic carrier material and compressed or adhered together to form a rigid or almost rigid composite, subsequently the windings of metallic wire are produced around the at least one magnetizable core corresponding to electric through-hole platings in printed circuit boards and at least one through hole through the multilayer layered structure at the location of the inner opening of one of the magnetizable cores and simultaneously or subsequently the base films or base plates are compressed to form the multilayer layered composite, subsequently the metallic windings are bonded with an electrically conductive connection, and subsequently a dielectric coating of the entire multilayer layered structure is applied.

And it is also advantageous if the coating is applied by immersion or spraying.

The in part substantial disadvantages of the solutions according to the prior art for conductivity sensors can be much improved with the solution according to the invention. In particular a sensor with much smaller dimensions can be produced, which can also be manufactured industrially throughout, without manual work being necessary. The multilayer technology provides a broad range of individual process steps that are well known according to the prior art and are now used for sensors of this type for the first time. The particular advantage lies in the multilayered arrangement of films or plates and elements, which renders possible a three-dimensional structure of the sensor and/or several identical or different sensors on a carrier substrate. These can also then be arranged separately from one another from insulation and/or passivation layers. The respective functional elements can be pressed onto the carrier substrates or even realized by substrate layers. The windings around the core materials can be realized according to the known principle of through-hole platings that meet on the conductor tracks of the films or plate lying underneath. They can also be produced in another known manner by bonding beyond the core material. Openings in individual or all ceramic or organic films or plates can also be easily produced and are also retained during subsequent process steps.

In this manner a considerable reduction of the production costs can be achieved.

With the solution according to the invention sensors can be disclosed with up to an 8-fold increase in sensitivity, for example. Low measurement tolerances also occur, which leads to a reduction in the dispersion of the sensor behavior, which simplifies adjustment and calibration.

Furthermore, additional functions can be easily integrated in a sensor-based manner by means of ceramic multilayer technology, which is not possible, or possible only with great complexity with the described methods according to the prior art. Examples of this are: electronic assemblies for measurement data processing, self-diagnosis/calibration and external interfaces. An arrangement of several inductive conductivity sensors or combinations of inductive conductivity sensors and those from other measurement principles or measured variables (e.g., pH value, temperature) on the same substrate is easily possible.

The multilayer structure of the sensor is rendered less susceptible to environmental effects by further process steps, e.g., by coating or immersing or spraying with plastic or glazing. Likewise, assembly is possible in a fixed, tight housing.

The invention is explained in more detail below based on two exemplary embodiments.

They show

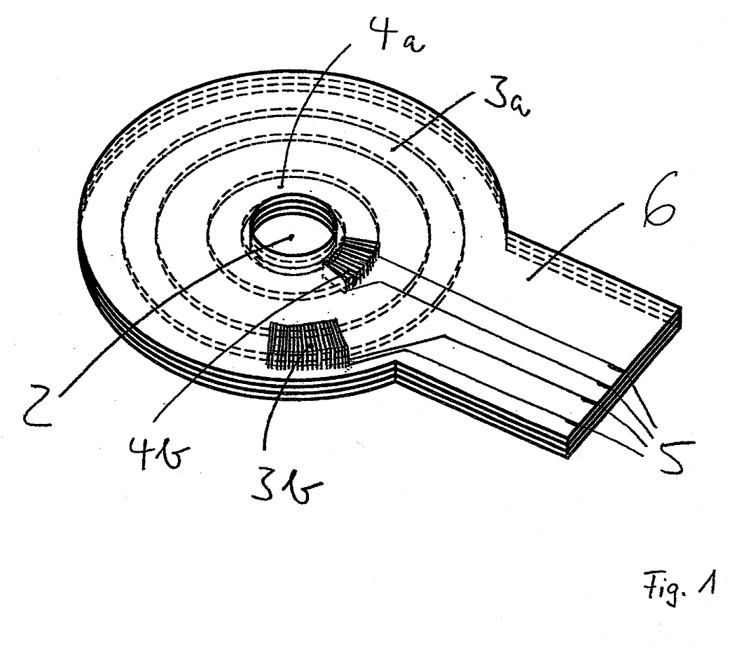

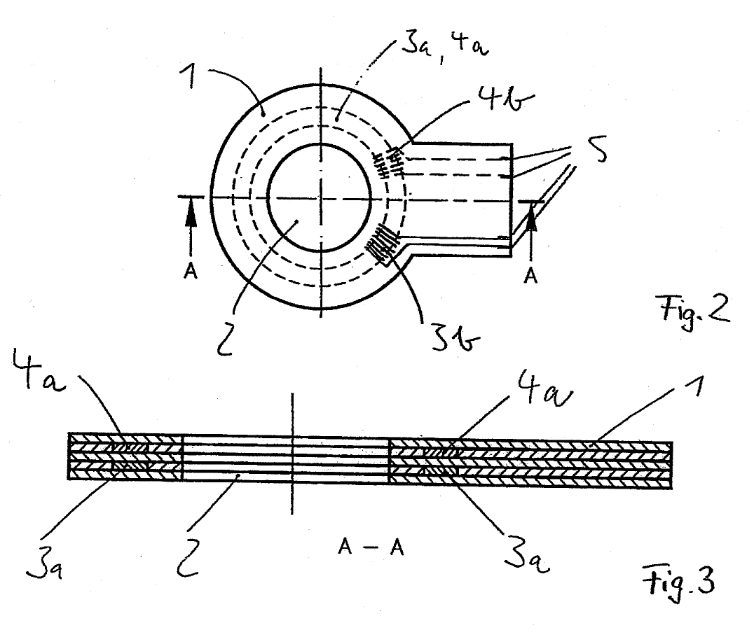

FIGS. 1, 2, 3: The view, the plan view and a section of the plan view of a sensor according to the invention of ceramic substrate material, in which the two magnetizable circular cores are arranged one above the other.

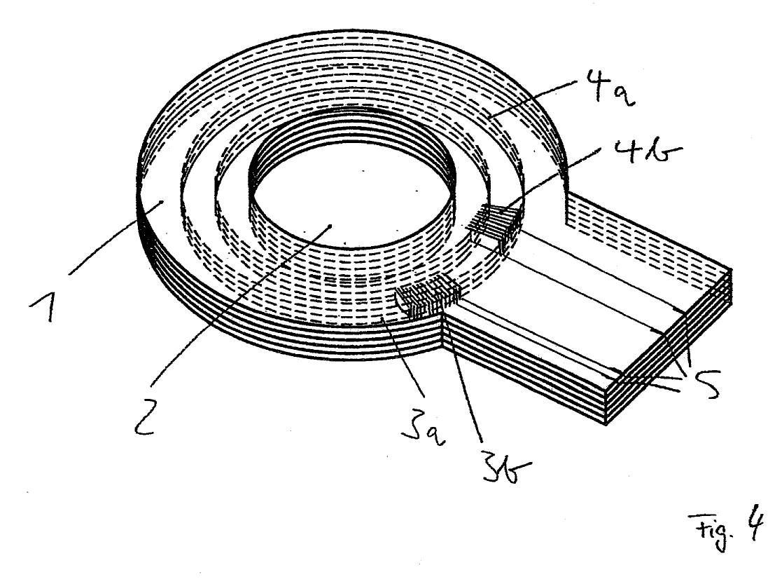

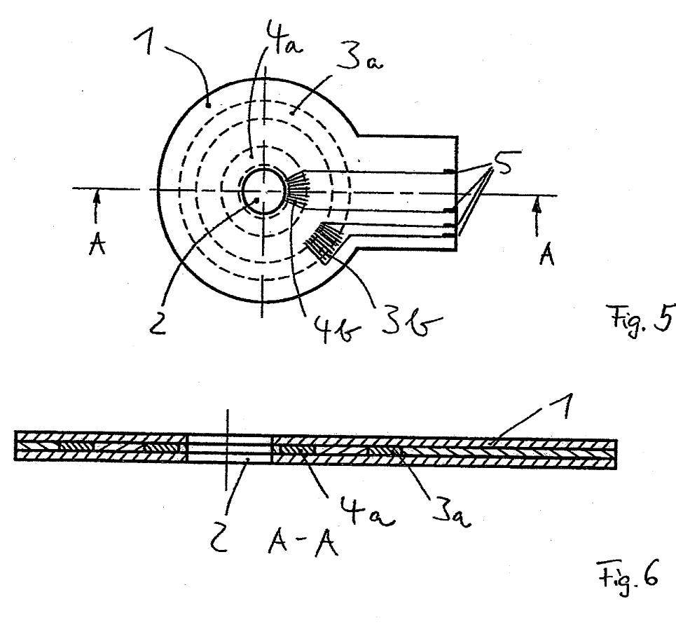

FIGS. 4, 5, 6: The view, the plan view and a section of the plan view of a sensor according to the invention of ceramic substrate material, in which the two magnetizable circular cores are arranged one inside the other in one plane.

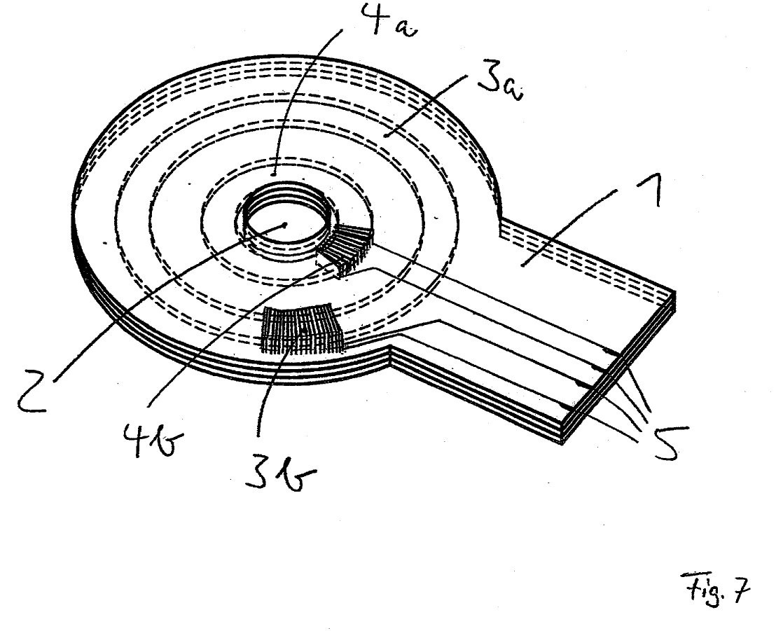

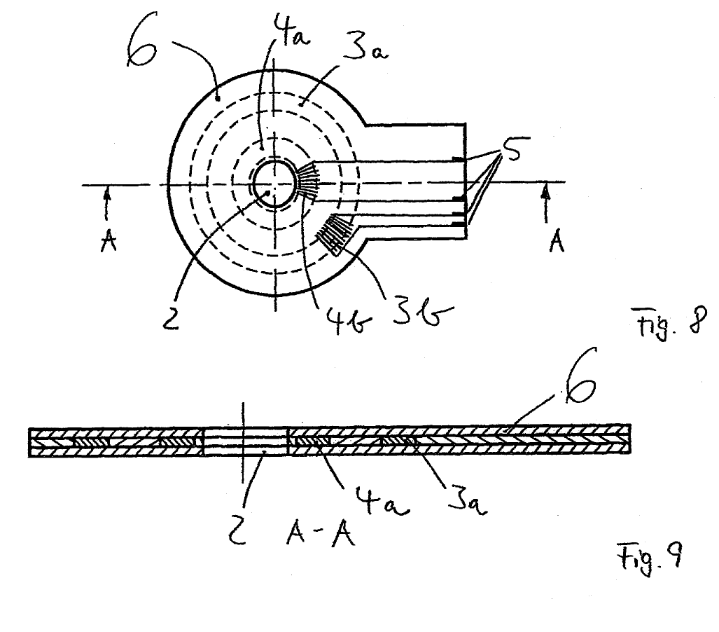

FIGS. 7, 8, 9: The view, the plan view and a section of the plan view of a sensor according to the invention of organic substrate material, in which the two magnetizable circular cores are arranged one above the other.

### LIST OF REFERENCE NUMBERS

1 Ceramic multilayer layered structure
2 Opening
3a Ferromagnetic core
3b Metallic windings around core 3a
4a Ferromagnetic core
4b Metallic windings around core 4a
5 Electrical connections
6 Organic multilayer layered structure

### EXAMPLE 1

Annular coils (3b, 4b) are advantageous for use in conductivity sensors, which annular coils are structured by means of ceramic multilayer technology. The conductors wound in coils (3b, 4b) according to the prior art are formed in ceramic multilayer technology as a combination of through-hole platings and printed conductor tracks. To this end first the openings for the through-hole platings are punched into the corresponding ferrite tapes jointly with the center opening (2) for guiding through the liquid to be detected) and subsequently metalized by means of screen printing. Subsequently the conductor tracks necessary to close the coil circuit are printed on the top and bottom. The approach described is carried out simultaneously for primary and secondary coils (3b, 4b). In this manner, the two coils receive 60 windings each. Subsequently LTCC films are laminated onto the outsides of the coated ferrite cores (3a, 4a), which LTCC films perform the bonding and packaging functions.

The entire multilayer layered structure (1) is sintered in nitrogen atmosphere for 2 hours 900° C.

After sintering, the arrangement described has a thickness of 1 mm and lateral dimensions of 20×30 mm².

After sintering, the structure is sprayed with a PEEK. The electrical connections (5) remain accessible from outside, likewise the opening is retained for the fluid to be measured through the cores. Subsequently the sensor has a thickness of 3 mm and lateral dimensions of 25 mm×35 mm.

The finished sensor is placed in a pipe via a pipe connection and anchored in the pipe with the opening lengthwise to the flow direction.

An aqueous solution flows through the subsequently opened pipe, the electrical conductivity of which solution is to be determined. After the sensor has been connected, the primary coil is acted on with an electric alternating voltage of IV and a frequency of 5 kHz. The current induced in the secondary coil is a gauge of the electrical conductivity of the aqueous solution. After a measurement period of 1 s a current of 0.3 μA is measured according to methods according to the prior art. From this measured value an electrical conductivity of the aqueous solution of 1 mS/cm is given.

### EXAMPLE 2

Annular coils (3b, 4b) are advantageous for use in conductivity sensors, which annular coils are structured by means of organic multilayer substrate technology. The conductors wound in coils (3b, 4b) according to the prior art are formed in circuit-board technology as a combination of through-hole platings and printed conductor tracks. To this end first in the laminated composite (6) of plates of an epoxide resin/glass fiber cloth mixture and annular cores of a soft magnetic nickel/iron alloy with 75-80% nickel content (3a, 4a), which is coated on the outsides with copper foil, next the conductor tracks necessary to close the coil circuit on the top and bottom are produced by etching. Subsequently the openings for the through-hole platings are drilled through the composite jointly with the center opening (2) for guiding through the liquid to be detected) and subsequently metalized. The approach described is carried out for primary and secondary coils (3b, 4b). In this manner, the two coils receive 60 windings each. Subsequently the primary and secondary coils are arranged one above the other and connected permanently by lamination or adhesion. Further layers of organic material, which perform packaging functions, are laminated or adhered onto the outsides of the composite. The electrical connections of the coils remain electrically bondable from outside. After sintering, the arrangement described has a thickness of 5 mm and lateral dimensions of 30×40 mm².

After sintering the structure is sprayed with a PEEK. The connections remain accessible from outside, likewise the opening is retained for the fluid to be measured through the cores. Subsequently the sensor has a thickness of 5 mm and lateral dimensions of 35 mm×45 mm.

The finished sensor is used like example 1.

1. Sensor for determining the electric conductivity of liquid media comprising a multilayer layered structure, which comprises at least one carrier substrate, on which at least two magnetizable cores with metallic windings at least partially enclosing over the length of the cores are arranged, electrically conductive feed lines and drain lines to the windings of the at least two cores are available, and the multilayer layered structure is enclosed at least by a dielectric layer, wherein in order to exploit the inductive measuring principle the arrangement of the sensor realizes an at least partial enclosure of the two wrapped and encased cores or core parts by the liquid at the same time.

2. Sensor according to claim 1, in which the carrier substrate is an electrically nonconductive ceramic, an LTCC ceramic (Low Temperature Cofired Ceramic) or an Al₂O₃ ceramic.

3. Sensor according to claim 1, in which the carrier substrate is an organic material.

4. Sensor according to claim 3, in which the organic material is phenolic resin+paper (FR1, FR2), epoxide resin+paper (FR3), epoxide resin+fiberglass cloth (FR4, FR5), polyimide and/or polyester.

5. Sensor according to claim 1, in which the multilayered layers comprise a ceramic that sinters densely at temperatures up to a maximum of 900° C.

6. Sensor according to claim 1, in which the magnetizable cores comprise a soft magnetic material.

7. Sensor according to claim 1, in which the magnetizable cores comprise a ferritic material.

8. Sensor according to claim 7, in which the ferritic material is used as a film or paste.

9. Sensor according to claim 1, in which the magnetizable cores are used as preformed solid bodies.

10. Sensor according to claim 1, in which the windings are composed of Cu, Ag, Pd, Au, Al or combinations of these materials.

11. Sensor according to claim 1, in which the magnetizable cores are arranged in an annular manner and/or one inside the other and/or one above the other and/or next to one another.

12. Sensor according to claim 1, in which the magnetizable cores are each surrounded by windings to 5 to 100%.

13. Sensor according to claim 1, in which the magnetizable cores are surrounded by windings respectively up to a maximum of 50% and the windings are arranged opposite one another.

14. Sensor according to claim 1, in which the entire multilayer layered structure has a height/thickness of 0.5 to 5 mm.

15. Sensor according to claim 1, in which the dielectric layer comprises a plastic or a glass.

16. Sensor according to claim 1, in which the signal transmission is realized via electric lines or by radio.

17. Sensor according to claim 1, in which further sensors are arranged on layers inside the multilayer layered structure.

18. Sensor according to claim 17, in which temperature and/or pH sensors are arranged inside the multilayer layered structure.

19. Sensor according to claim 1, in which several magnetizable pairs of cores with windings are present on a carrier substrate, wherein to exploit the inductive measuring principle the liquid surrounds at least in part all of the wound and encased cores or core parts simultaneously here too.

20. Method for production of a sensor for determining the electric conductivity of liquid media according to claim 1, in which at least one greenbody for a magnetizable core of a ferritic ceramic material is applied onto a dielectric ceramic base green film, which greenbody is wrapped by a metallic wire, wherein to realize the inductive measuring principle at least one second magnetizable core with windings of a metallic wire is applied to the same or to a different dielectric ceramic film, and the windings have been plated-through by the ceramic film/films, subsequently the metallic windings are bonded with an electrically conductive compound and subsequently the sintering of the ceramic multilayer layered structure is carried out, wherein a dielectric encasing of the entire multilayer layered structure is applied before or after the sintering.

21. Method according to claim 20, in which dielectric ceramic base green films with a thickness of 50 to 250 μm are used.

22. Method according to claim 20, in which the sintering of the multilayer layered structure is carried out at temperatures of no more than 900° C.

23. Method according to claim 20, in which an encasement of plastic or glass is applied at temperatures of no more than 900° C.

24. Method for producing a sensor for determining the electric conductivity of liquid media according to claim 1, in which at least one magnetizable core is placed on an organic base film or base plate and covered with at least one further layer of organic carrier material and compressed or adhered together to form a rigid or almost rigid composite, subsequently the windings of metallic wire are produced around the at least one magnetizable core corresponding to electric through-hole platings in printed circuit boards and at least one through hole through the multilayer layered structure at the location of the inner opening of one of the magnetizable cores and simultaneously or subsequently the base films or base plates are compressed to form a multilayer layered composite, subsequently the metallic windings are bonded with an electrically conductive composite, and subsequently a dielectric coating of the entire multilayer layered structure is applied.

25. Method according to claim 1 in which the coating is applied by immersing or spraying.
